(19) United States
(12) Patent Application Publication
(10) Pub. No.: US 2007/0298397 A1
(43) Pub. Date: Dec. 27, 2007

(54) TRAFFIC SPEED CONTROL METHOD

(76) Inventor: Bobby G. Thomas, Dyer, IN (US)

Correspondence Address: HARTMAN & HARTMAN, P.C., 552 EAST 700 NORTH, VALPARAISO, IN, 46383, US

(21) Appl. No.: 11/425,729

(22) Filed: Jun. 22, 2006

(51) Int. Cl. G09B 19/14

(52) U.S. Cl. 434/305

(57) ABSTRACT

A traffic control method in which a two-dimensional, full-sized replica of a police car is placed relative to a road and its passing traffic so that the replica appears to be an actual police car to drivers. The method generally includes providing the replica to have a size and configuration corresponding to an actual police car, transporting the replica to a location where the replica is seen from a road, and supporting the replica at the location so that the replica is located, oriented, sized, and configured so as to appear to be the actual police car on traffic control duty to drivers on the road. The replica is supported so that it can be rapidly relocated to multiple additional locations to regulate traffic.

### BACKGROUND OF THE INVENTION

The present invention generally relates to traffic control methods and equipment. More particularly, this invention relates to a method of using a two-dimensional replica of a police car for traffic control.

The presence of police cars has a significant impact on the enforcement of highway speed limits, but the frequency of their presence at any one location is limited by considerations of cost and manpower. Consequently, unstaffed cars configured as dummy police cars and parked along roadsides have been used for speed enforcement. However, dummy police cars are relatively expensive, and their deterrent effect weakens if they are left parked for extended periods due to limited resources.

Accordingly, there is an ongoing need for methods by which cost-effective and portable speed enforcement can be provided.

### BRIEF SUMMARY OF THE INVENTION

The present invention provides a traffic control method in which a two-dimensional, full-sized replica of a police car is placed relative to a road and its passing traffic so that the replica appears to be an actual police car to drivers.

The method of this invention generally includes providing the replica to have a size and configuration corresponding to an actual police car, transporting the replica to a location where the replica is seen from a road, and supporting the replica at the location so that the replica is located, oriented, sized, and configured so as to appear to be the actual police car on traffic control duty to drivers on the road. The replica is supported so that it can be rapidly relocated to a second location to regulate traffic.

The replica can portray a variety of views of a police car, including front, side, and rear views. The replica can also be mounted on a wheeled support apparatus, staked in the ground, and provided with a power generator along with operable lights and/or radar transceiver to render the replica more realistic. With or without these additional features, the two-dimensional replica of this invention offers significant cost and practical advantages over dummy police cars and other methods intended to achieve traffic control.

Other objects and advantages of this invention will be better appreciated from the following detailed description.

### BRIEF DESCRIPTION OF THE DRAWINGS

FIGS. 1, 2, and 3 represent two-dimensional replicas depicting front, rear, and side views, respectively, of police cars in accordance with different embodiments of the invention.

FIGS. 4 and 5 represent backside views of the replicas of FIGS. 2 and 3, respectively, and show the replicas being staked for support in accordance with a first aspect of the invention.

FIG. 6 represents a side view of any one of the embodiments of FIGS. 1, 2, and 3, and shows the replica being supported with a wheeled mobile apparatus in accordance with a second aspect of the invention.

### DESCRIPTION OF THE INVENTION

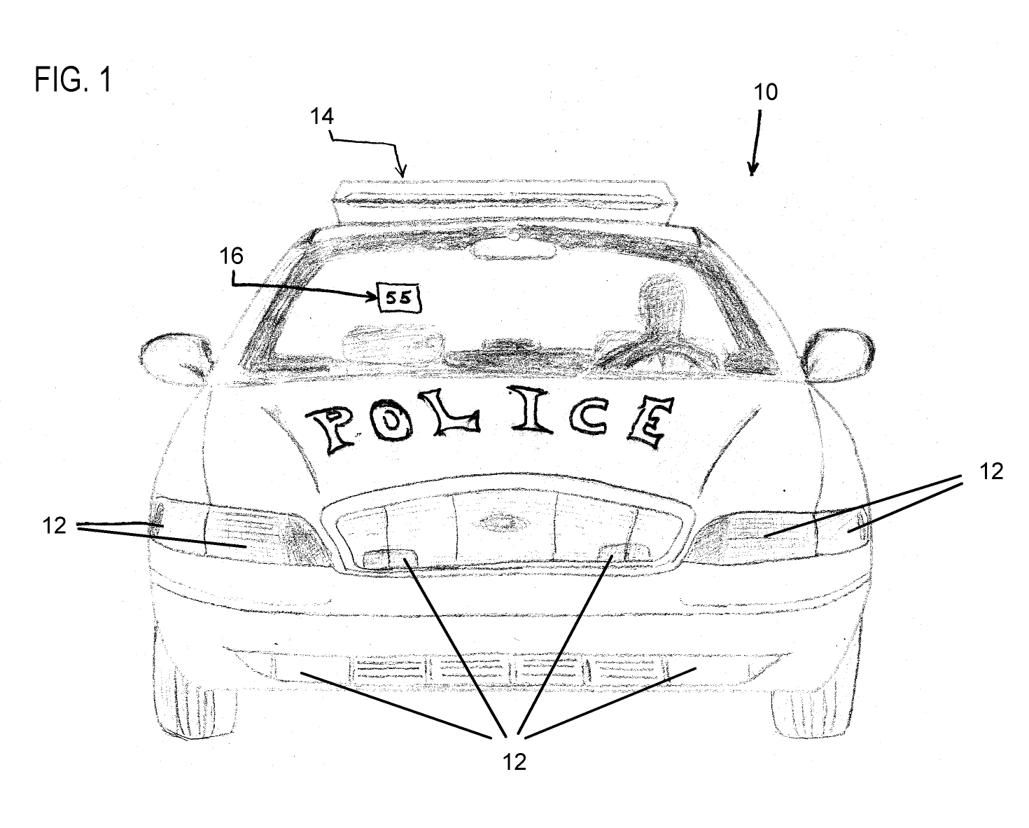

Illustrated in FIGS. 1 through 3 are three alternative versions of two-dimensional police car replicas in accordance with the invention. Referring initially to FIG. 1, a replica 10 is depicted as a front view of an actual police car, and as such is preferably sized, has the silhouette of, and graphically depicts what appears to be an actual police car. The replica 10 is represented as having vehicle lights 12 (e.g., head lights, running lights, parking lights, etc.) and a light bar 14 on the top of the replica 10 corresponding to the roof of the police car. The replica 10 is also represented as having an opening in which is mounted an operable radar transceiver 16 that can be operated to assist in the enforcing of traffic speed. For example, the radar transceiver 16 can be operated to measure traffic speed and broadcast any traffic violations to nearby police cars. As such, the replica 10 has the appearance of a full-sized frontal view of an actual police car to passing traffic. The lights 12 and light bar 14 can be operational and powered by a suitable power source to enhance the desired deterrent effect, especially at night.

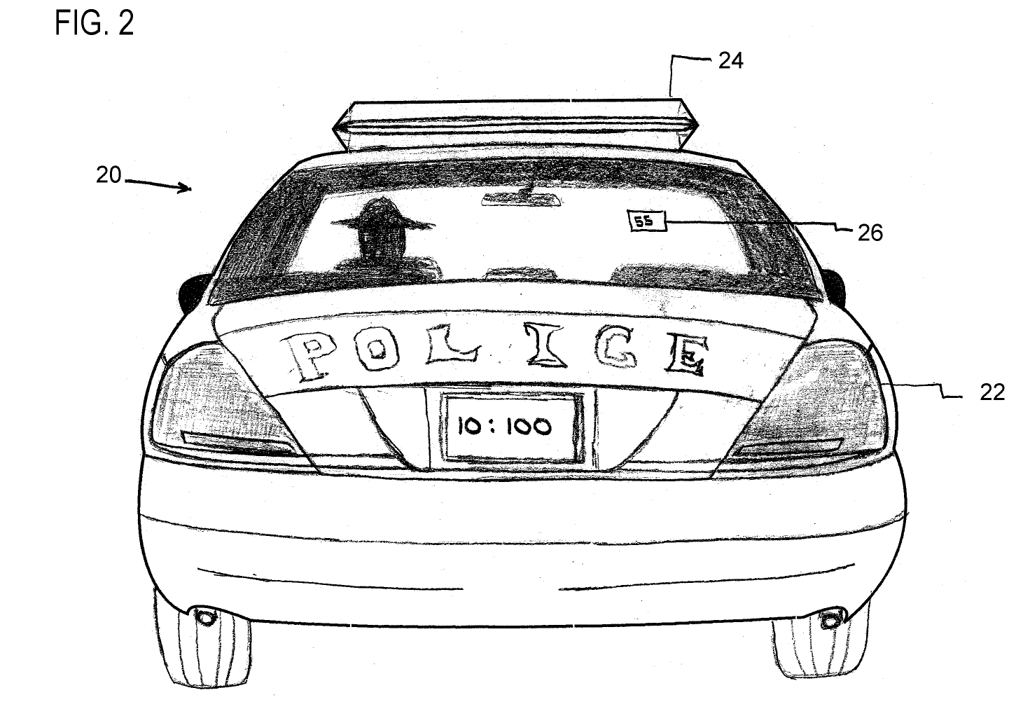

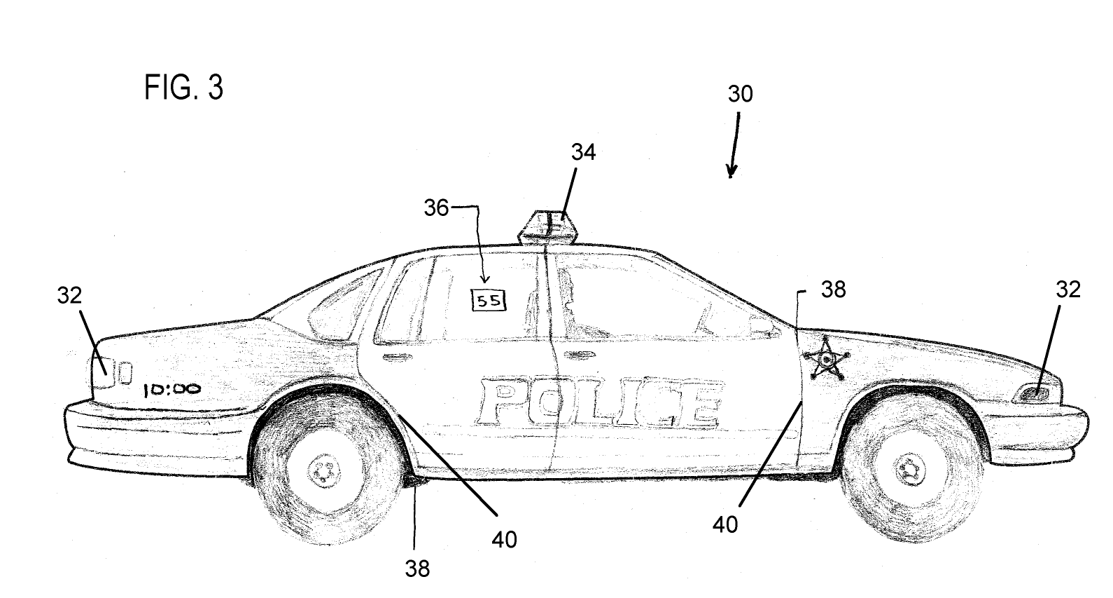

FIG. 2 shows a replica 20 depicting a rear view of a police car, and FIG. 3 shows a replica 30 depicted a side view of a police car. These replicas 20 and 30 are represented as being similarly equipped with lights 22 and 32, light bars 24 and 34, and radar transceivers 26 and 36, which may be operational in accordance with the description of FIG. 1. The replica 30 of FIG. 3 is also represented as having hinges 38 located at fold lines 40 of the replica 30, by which the replica 30 can be folded onto itself to facilitate transporting the replica 30.

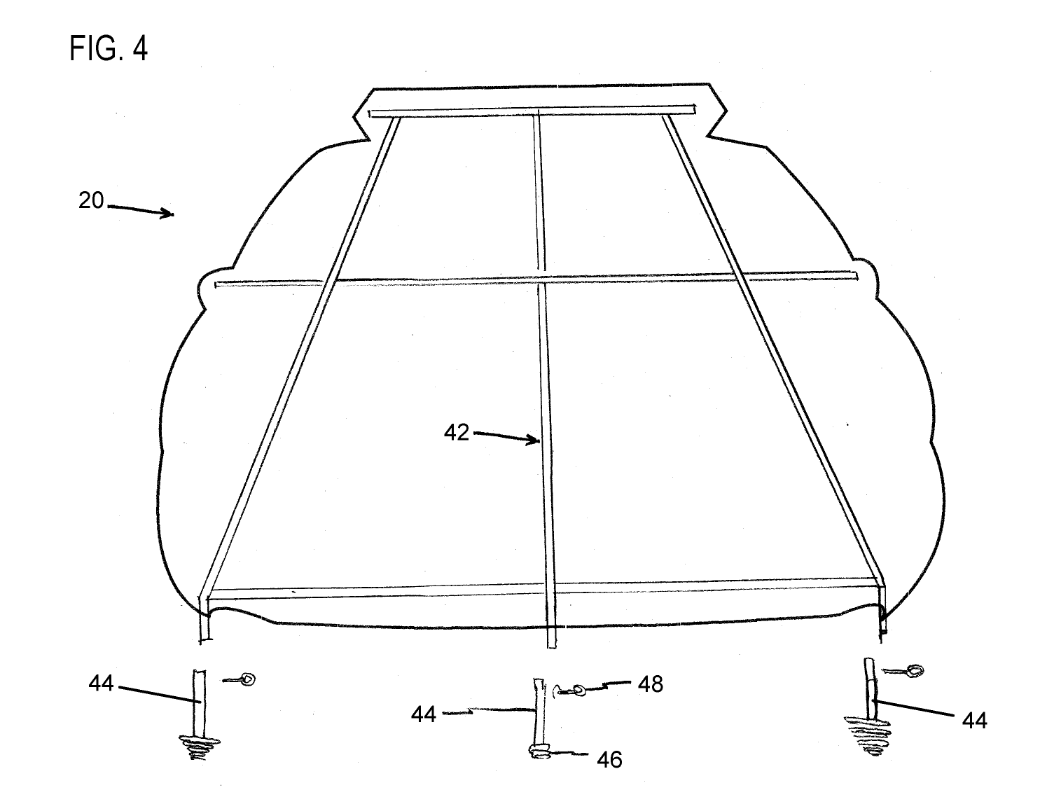

FIG. 4 represents a backside view of the replica 20 of FIG. 2, in which an A-shaped support frame 42 is attached to the back of the replica 20 and adapted to be mounted on stakes 44. The frame 42 and stakes 44 can be formed of tubing to promote strength and facilitate assembly and mounting of the replica 20. Each stake 44 is represented as being equipped with an auger 46 to facilitate staking and a pin 48 to secure the lower extensions of the frame 42. FIG. 4 similarly represents a backside view of the replica 30 of FIG. 3, in which a support frame 50 is attached to the back of the replica 30. The frame 50 is presented as being securable with pins 54 to augers 52 that can be driven into the ground. As such, the deterrent effect of the replicas 20 and 30 is enhanced by the ability to quickly move the replicas 20 and 30 from site to site as needed.

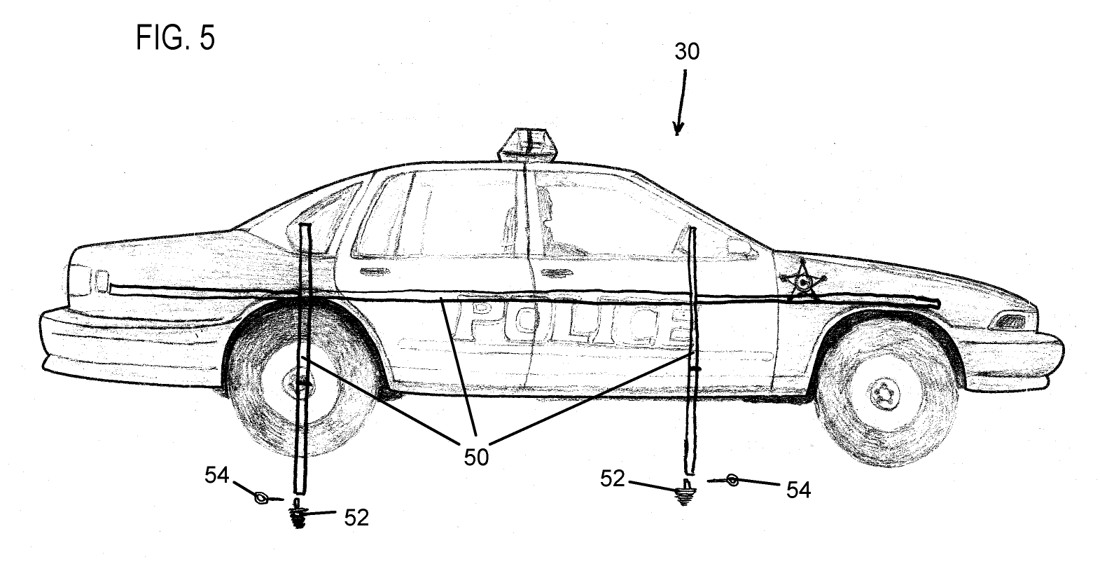

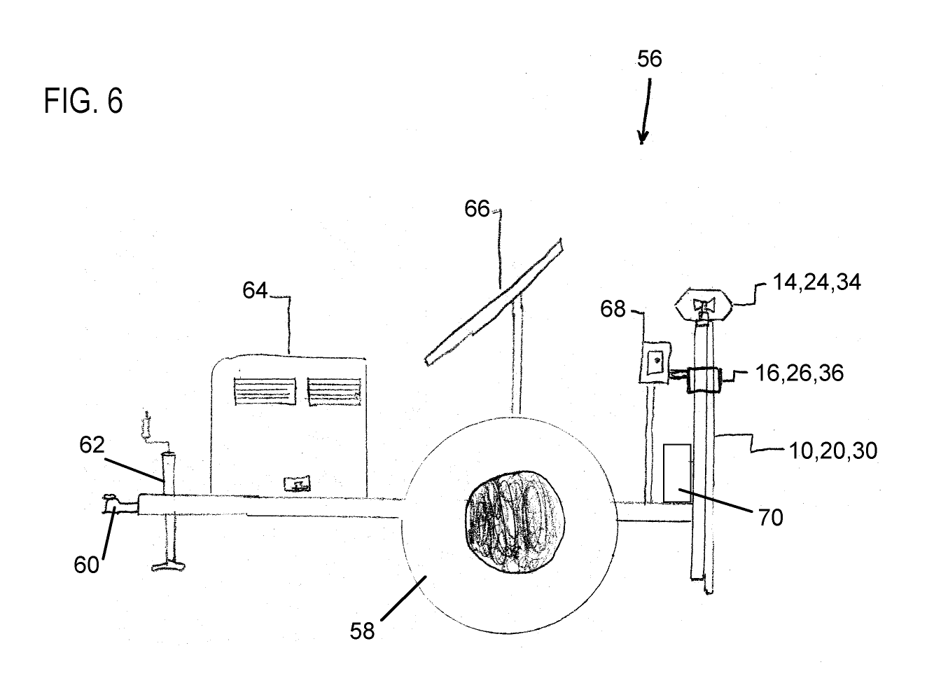

FIG. 6 represents an alternative to the staking approach shown in FIGS. 4 and 5, in which any one of the replicas 10, 20, and 30 is mounted to a wheeled trailer 56 that both transports the replica 10, 20, or 30 to a desired site, and then supports the replica 10, 20, or 30 at the site. The trailer 56 is shown as including wheels 58, a hitch 60 for towing the trailer 56, and a jack stand 62 for supporting the tongue of the trailer 56 when parked. The trailer 56 and its wheels 58, hitch 60, and jack stand 62 can be of any suitable type. Two alternative sources of power a generator 64 and a solar collector 66—are shown mounted on the trailer 56. The trailer 56 can be equipped with both, either, or neither, as desired. A breaker box 68 electrically connects any electrically powered devices on the replica 10, 20, or 30, such as the lights 12, 22, or 32, light bars 14, 24, or 34, and radar transceivers 16, 26, and 36 discussed with the preceding embodiments, as well as any other devices 70 that might be desired, including equipment necessary to wirelessly send and receive video, images, output from the radar transceivers 16, 26, and 36, and/or information regarding the location, operational status, etc., of the replica 10, 20 or 30 and trailer 56.

While the invention has been described in terms of preferred embodiments, it is apparent that other forms could be adopted by one skilled in the art. Therefore, the scope of the invention is to be limited only by the following claims.

1. A method of traffic speed control, the method comprising the steps of:
providing a two-dimensional replica having a size and configuration corresponding to an actual police car;
transporting the replica to a location where the replica is seen from a road; and
supporting the replica at the location so that the replica is located, oriented, sized, and configured so as to appear to be the actual police car on traffic control duty to drivers on the road, the replica being supported to enable the replica to be rapidly relocated to a second location to regulate traffic.

2. A method according to claim 1, wherein the replica is formed to have a shape corresponding to a front view of the actual police car.

3. A method according to claim 1, wherein the replica is formed to have a shape corresponding to a side view of the actual police car

4. A method according to claim 1, wherein the replica is formed to have a shape corresponding to a rear view of the actual police car.

5. A method according to claim 1, wherein the replica is configured to be foldable onto itself.

6. A method according to claim 1, wherein the replica has a light bar and head lights capable of being illuminated.

7. A method according to claim 1, wherein the replica is electrically connected to a power generating means.

8. A method according to claim 7, wherein the replica comprises a radar transceiver that is electrically connected to the power generating means and operated to monitor traffic speed.

9. A method according to claim 7, wherein the replica has a light bar and head lights electrically connected to the power generating means and illuminated therewith.

10. A method according to claim 7, wherein the replica is supported with a wheeled support apparatus on which the power generating means is mounted.

11. A method according to claim 1, wherein the replica is supported with stakes.

12. A method of traffic speed control, the method comprising the steps of:
providing a two-dimensional replica having a size and configuration corresponding to an actual police car, an opening in which is mounted a radar transceiver, a light bar on an upper portion thereof corresponding to a roof of the actual police car, and lights located on a lower portion thereof;
transporting the replica to a location where the replica is seen from a road;
supporting the replica at the location so that the replica is located, oriented, sized, and configured so as to appear to be the actual police car on traffic control duty to drivers on the road, the replica being supported to enable the replica to be rapidly relocated to a second location to regulate traffic;
providing electrical power the radar transceiver, the light bar, and the lights; and
monitoring speed regulations by operating the radar transceiver to measure traffic speed and broadcast any traffic violations to nearby police cars.

13. A method according to claim 12, wherein the replica is formed to have a shape corresponding to a front view of the actual police car.

14. A method according to claim 12, wherein the replica is formed to have a shape corresponding to a side view of the actual police car.

15. A method according to claim 12, wherein the replica is formed to have a shape corresponding to a rear view of the actual police car.

16. A method according to claim 12, wherein the replica is configured to be foldable onto itself.

17. A method according to claim 12, wherein the replica is supported with a wheeled support apparatus on which means for generating the electrical power is mounted.

18. A method according to claim 12, wherein the replica is supported with stakes.
